(19) United States
(12) Patent Application Publication
(10) Pub. No.: US 2003/0190037 A1
(43) Pub. Date: Oct. 9, 2003

(54) Method for automated dialing of telephone number prefixes

(76) Inventor: John Hruska, Port St. Lucie, FL (US)

Correspondence Address: MCHALE & SLAVIN, P.A., 2855 PGA BLVD, PALM BEACH GARDENS, FL, 33410, US

(21) Appl. No.: 10/117,649

(22) Filed: Apr. 4, 2002

(51) Int. Cl. H04M 1/00; H04M 3/00

(52) U.S. Cl. 379/355.01

(57) ABSTRACT

A method for appending a dialing prefix to a telephone number digit string which has been dialed from a calling party is provided which comprises the steps of storing the dialed telephone number digit string in a buffer, marking the telephone number digit string stored in said buffer to define the local line number, checking whether the dialing prefix and local line number provides a valid network address, determining a correct dialing prefix to reach the destination party, advising the calling party via a computer-generated audio message of the correct dialing prefix required to reach the destination party, appending the correct area code prefix to the local line number; and automatically connecting the call to a destination party. The dialing prefix can include 1+, 0+, area codes, international access codes, and foreign country and city codes. The caller can be prompted for manual input of the correct dialing prefix using the touch tone keypad, or the prefix can be appended automatically. The method can include the steps of advising the caller via a computer-generated audio message that a fee will be incurred for automatic placement of the call. In a second embodiment, the caller can dial a seven-digit number and select the desired geographic region from an audio menu. In a third embodiment for a telephone system having a single area code assigned to a plurality of regions, a method is provided by which calling party can dial a ten-digit number and select the desired geographic region from an audio menu.

### FIELD OF THE INVENTION

This invention relates generally to services for telephone system subscribers, and more particularly to a method of automatically appending a telephone number prefix to a local line number.

### BACKGROUND OF THE INVENTION

All countries have their individual numbering plans that specify how telephone numbers are structured within the country. To route telephone calls between networks, telephone switching systems require dialing prefixes which may include 1+, 0+, area codes, international access codes, and foreign country and city codes. In the United States and other North American countries, the telephone numbering is standardized by the North American Numbering Plan (NANP), which is described herein for illustration purposes. NANP numbers are ten digits in length, where the first three digits are called the area code, the second three digits are called the central office code and the last four digits are the line number.

The NANP was developed in 1947 by AT&T and Bell Laboratories to create a standardized numbering plan for long distance dialing. This development allowed long distance dialing without the need for operator assistance. Prior to the NANP system, all telephone numbers in North America had seven digits. If someone wanted to make a long distance call, the caller dialed the “0” on the telephone, gave the operator the desired city and seven-digit telephone number, and often hung up to wait for the call to be completed. It could take up to 10 minutes or so to switch a coast-to-coast call manually like this, proceeding trunk by trunk and operator to operator across the country.

In the early 1960s, the AT&T Bell System introduced area codes, technically called numbering plan assignments (NPAs). The original 10-digit NPA system had to have a digit from 2 to 9 in the first position (designated N), a 0 or 1 in the second position, and could have any digit from 0 to 9 in the third position (designated X). Thus the original NPA plan had an N0/1X structure. This made it easy to tell when a caller dialed a long distance call, since exchange code had an NNX structure that meant a 0 or 1 never appeared in a valid local call this allowed long-distance calls to be routed immediately onto special long-distance trunks, enabling quicker call completion and thus more calls handled per unit time. The last four digits had an XXXX structure, although some numbers were routinely reserved for special uses (99XX numbers were usually used internally). All calls that began with a 0 or 1 were special in the sense that they were neither local nor long distance.

In some parts of the United States, mostly those with major metropolitan areas, the NNX structure limited the number of central offices. Rather than add many new areas codes, NXX was allowed in these areas, starting in 1971. This allowed a 0 or 1 in the second position of the dialed number for local calls, so there was now no easy way to identify long-distance calls immediately. Thus, in those areas, users were forced to dial a 1 before making a long-distance call, adding an eleventh digit to the number. It could be argued that the switch could just wait until the caller dialed 7 or 10 digits, but the digit register was assigned before the digits were dialed. Since most calls were local calls, the default number of digits captured was 7. Also, waiting for all dialed digits slowed call processing, users often paused during dialing, and so on.

In recent years, the number of assigned telephone numbers has exploded, in part because of the proliferation of cellular telephones, and the demand for multiple telephone lines for fax machines and computer Internet access. This demand has put so much pressure on the area code structure that in 1995 the North American numbering plan allowed NPAs in the form of NXX. When the available numbers in a given area code region are nearly exhausted, the region may be split so that a portion of the region has a new area code. In some areas, callers have no choice but to dial the full 10 digits all the time, even when calling a neighbor next door

The increasing frequence of area code changes can be troublesome for the caller, who has added difficulty in determining the correct number for the destination party. When an area code is changed, there is an interim period when the caller is informed by an automated message that the area code has changed and provides the caller with the correct area code. Or, if an invalid seven-digit number is dialed, the caller is informed by an automated message that “one or zero plus the area code” must be dialed in order to complete the call. Then caller then needs to look up the number, perhaps by dialing directory assistance. In both of these scenarios, it is necessary for the caller to hang up and re-dial the number. This can be annoying to the caller, and can seem to the caller to be a waste of the caller's time. From the perspective of the caller, it would be desirable to simply enter the required prefix digits after the number is initially dialed, or have the prefix appended to the dialed number automatically, instead of hanging up and beginning again.

In the prior art, there are numerous systems for simplified area code dialing which disclose localized “speed dialing” type systems where there entire phone number is previously stored in a memory, either within the telephone itself or in a separate CPU. When the seven digit number is dialed, the full number with area code or international calling codes is retrieved from memory and dialed. Examples of this type of system are seen in Theis, U.S. Pat. No. 6,201,864, Yim, U.S. Pat. No. 6,192,124, Breeden, U.S. Pat. No. 5,459,774, Boakes, U.S. Pat. No. 5,946,390, Waldman, U.S. Pat. No. 5,157,719, McIntosh, U.S. Pat. No. 6,169,799, Nixon et al., U.S. Pat. No. 5,475,743, and Gabarra, U.S. Pat. No. 6,292,557. These systems require the number to have been previously stored by the caller, and would not be useful in a situation where the caller does not know the correct dialing prefix.

Brendzel et al., U.S. Pat. No. 5,859,901, discloses a centralized data base system for adding the correct area code to a seven digit number. However, the system determines the correct area code by analyzing the historical calling pattern of the originating telephone and the distance between the calling party and the receiving party. This system has inherent disadvantages and limitations, since an error could easily be made by simply basing the determination on physical distance. Further, a change in the area code for the receiving party an error, all of which leads to consumer confusion and associated complaints.

Under the NANP ten-digit system, the growing demand for new telephone numbers will result in an ever-increasing rate of creation of new area codes. This situation has created a need for a simplified prefix dialing system which can be integrated with existing directory assistance resources to streamline the dialing process for the caller.

### SUMMARY OF THE INVENTION

It is an objective of the invention to provide method for storing the digit string of a dialed number in a buffer and automatically appending the correct prefix to the number and completing the call, without the caller having to redial the entire number.

It is another objective to provide a method of appending a telephone number prefix to a local line number which can be integrated with an automated directory assistance system to allow the caller to quickly determine the correct dialing prefix.

It is still another objective to provide a simplified method for locating and dialing area codes which can be implemented with straightforward modification existing telecommunication network systems.

In accordance with the above objectives, a method for appending a dialing prefix to a telephone number digit string which has been dialed from a calling party is provided which comprises the steps of storing the dialed telephone number digit string in a buffer, marking the telephone number digit string stored in said buffer to define the local line number, checking whether the dialing prefix and local line number provides a valid network address, determining a correct dialing prefix to reach the destination party, advising the calling party via a computer-generated audio message of the correct dialing prefix required to reach the destination party, appending the correct area code prefix to the local line number; and automatically connecting the call to a destination party. The dialing prefix can include 1+, 0+, area codes, international access codes, and foreign country and city codes. The caller can be prompted for manual input of the correct dialing prefix using the touch tone keypad, or the prefix can be appended automatically.

The method can include the steps of advising the caller via a computer-generated audio message that a fee will be incurred for automatic placement of the call. The caller can then be prompted for confirmation that the call is to be automatically connected. The confirmation can be accomplished by manual keypad entry.

In a second embodiment of the invention, a method is provided wherein a calling party can place an inter-LATA telephone call to a destination party by entering the local line number and selecting the geographic location of the destination party from a menu. The method comprises the steps of storing the digit string dialed by the calling party in a buffer, querying a directory database to locate the total the number of matching local line numbers in the telephone system corresponding the local line number of the destination party, querying the directory database to obtain the associated area codes and geographic locations for the matching local line numbers, assigning a numeric value to each matching local line number, and delivering to the calling party a computer-generated audio message in which each geographic location for the matching local numbers, and associated numeric values assign thereto, is conveyed to the calling party with instructions to the calling party to select the desired geographic location by pressing touch tone keys on the local telephone device corresponding to the assigned numeric value of the selected geographic location. The area code for the selected geographic location is then appended to the local line number stored in the buffer and the call is connected to the destination party.

A third embodiment of the invention contemplates a telephone system having a numbering system where a single area code assigned to a plurality of noncontiguous geographic regions. In such a system, the invention provides a method by which a calling party can dial a digit string including the area code and selectively direct the call to the desired geographic region. The method comprises the steps of querying a data base to determine all geographic regions assigned to the area code, assigning a numeric value to each geographic region, delivering to the calling party a computer-generated audio message in which each geographic location and associated numeric values assign thereto are conveyed to the calling party with instructions to the calling party to select the desired geographic location, and connecting the call upon receiving the calling party selection. The calling party can either enter the numeric value on the touch tone keypad or, if speech recognition systems are utilized, vocalize the number.

A database query can be executed to locate all ten-digit numbers in the telephone system which match the dialed digit string. The total number of existing exact matches is determined, and in the event a single exact match exists, the call is connected. The method can include the step of eliminating from the audio menu all geographic regions where an exact match does not exit.

### BRIEF DESCRIPTION OF THE FIGURES

FIGS. 1A-C are diagrammatic illustrations of a telephone number string stored in a buffer according to the method of the invention;

FIG. 2 illustrates the steps for automatic completion of a telephone call dialed with an incorrect prefix according to the preferred embodiment of the method of the invention

FIG. 3 illustrates the steps of prompting the caller for manual entry of the correct prefix;

FIG. 4 illustrates the steps of advising the caller that a fee will be incurred;

FIG. 5 illustrates a method according to a second embodiment of the invention in which a caller is presented with a menu from which the desired geographic location can be selected; and

FIG. 6 illustrates the steps of the method shown in FIG. 5.

FIG. 7 illustrates a third embodiment of the invention which includes a method for completing a 10-digit call according to in a system where duplicate area codes are assigned to noncontiguous geographic regions.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

The present invention provides a method for automatically completing a telephone call in which a digit string has been dialed by the calling party with an incorrect dialing prefix. The dialing prefix can include 1+, 0+, area codes, international access codes, and foreign country and city codes. The method of the invention is readily achieved by straightforward modification of the software known in the art that operates telecommunication networks. The illustrative discussion herein of the principles of the invention concerns the ten digit system of the North American Numbering Plan (i.e. “X-XXX-XXX-XXXX”). It will be understood, however, that the method of the invention is not limited in this regard, and that the principles of the invention are also applicable to telephone digit strings of any length. Moreover, it should be recognized that the method of invention is not limited to the telecommunications industry, and can be used in any system utilizing keyed alphanumeric input.

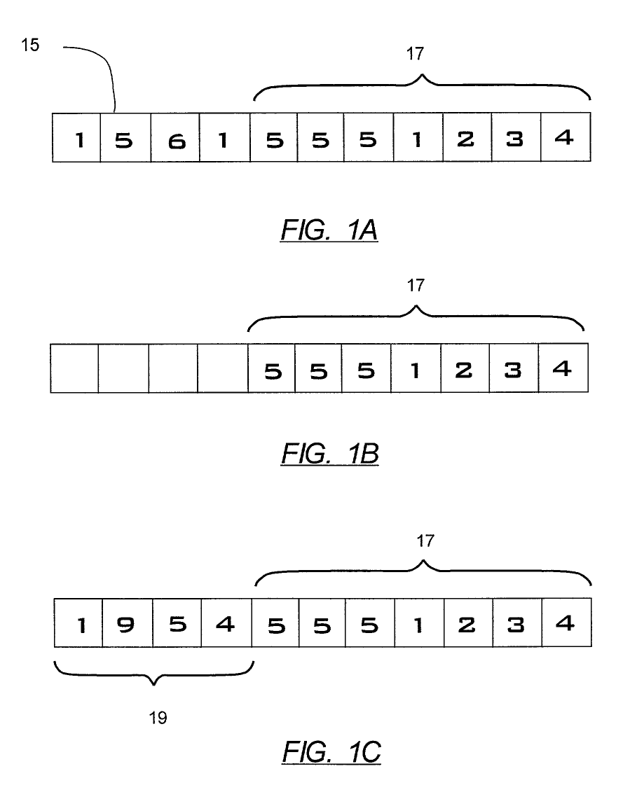

In the method of the invention, the digit string as initially dialed is stored in a buffer 15, as is diagrammatically illustrated in FIG. 1A. The buffer of the present invention can have any suitable physical implementation. The buffer 15 can be integral to the local device, or can be incorporated into a PBX box at the user site. The buffer 15 can also be located within the telephone system network. As shown in FIG. 1B, the digit string, which in this example includes an incorrect prefix, is truncated so that it includes only the seven-digit line number 17. In FIG. 1C, the correct prefix 19 is then inserted into the buffer 15 so as to be appended to the line number 17, thus forming the correct dialing string for the destination party.

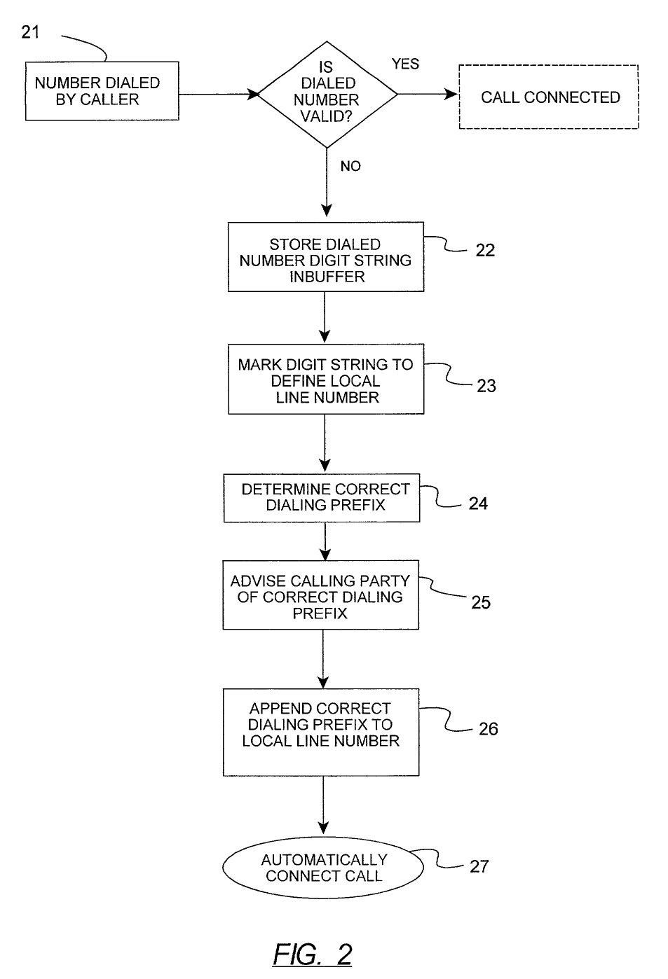

FIG. 2 illustrates the steps 20 of the method of the invention. In step 21, the calling party dials the digit string of the destination party. If the number is valid, the call is connected to the destination party in the normal fashion. If the number is not valid, the dialed string is stored in the buffer (step 22). The digit string is marked to define the local line number, as described above (step 23).

In step 24, the correct dialing prefix is determined. The method of determining the correct dialing prefix depends on specific factors. For example, when a new area code is implemented in a region, there is an interim period where the correct area code can be automatically determined. It can be assumed that if a caller is dialing 1-407-123-4567, and the area code has been recently changed to 561, that the number the caller is seeking is 1-561-123-4567. In this instance, the caller is informed of the new area code by an automated message (step 25). If the correct area code cannot be automatically determined, the caller can be automatically connected to a directory assistance system to obtain the correct area code. The caller is advised 25 of the correct area code, either by a human operator or by an automated messages.

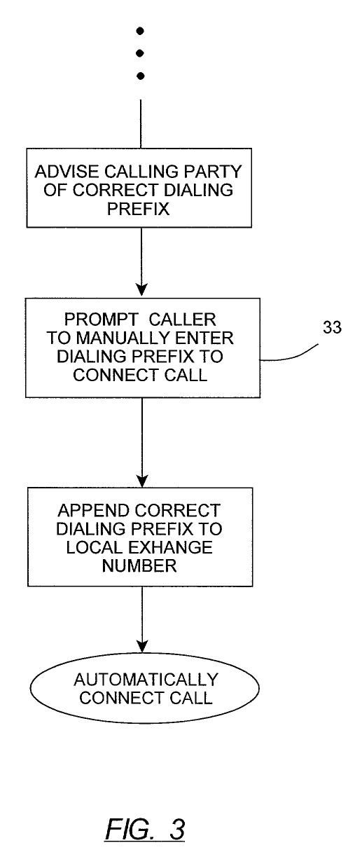

In step 26, the correct prefix is appended to the local line number in the buffer to form the correct digit dialing string. Using the correct number, the call is then connected to the destination party (step 27). The prefix can be appended to the line number automatically, or can be manually entered by the caller. Referring now to FIG. 3, in step 33 the caller is prompted to manually enter the correct prefix into the buffer, and the call is then automatically connected 34.

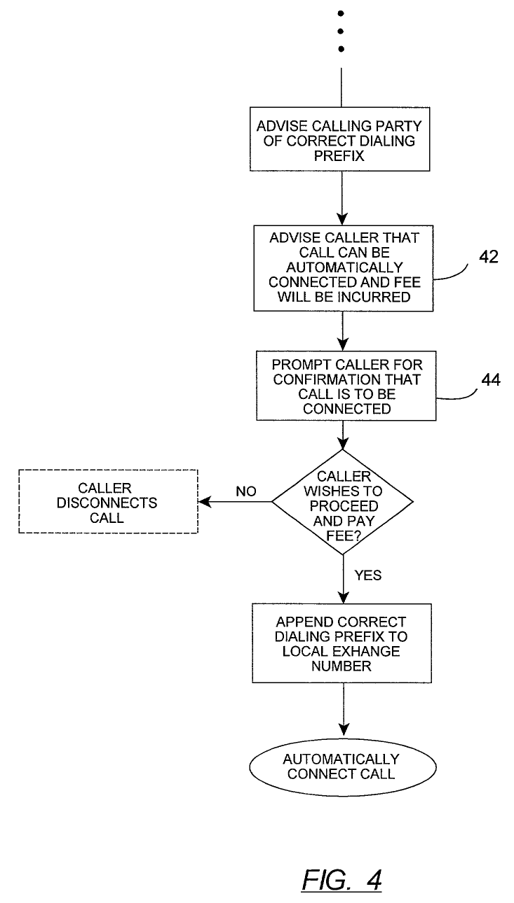

The method of the present invention enables the caller to complete the call after obtaining the correct dialing prefix without redialing the number. To provide the caller with this convenience, the invention can include the step of a charging fee to the caller for the automatic completion of the call, or a lesser fee for manual entry. As shown in FIG. 4, the caller is advised in step 42 that the call can be automatically connected and a fee will be incurred. In step 44, the caller is prompted for confirmation that the call is to be connected for a fee. The caller can confirm acceptance of the fee by simply staying on the line. The fee can also be accepted by a keypad entry or spoken utterance if a voice recognition systems are used. The caller can decline by disconnecting the call.

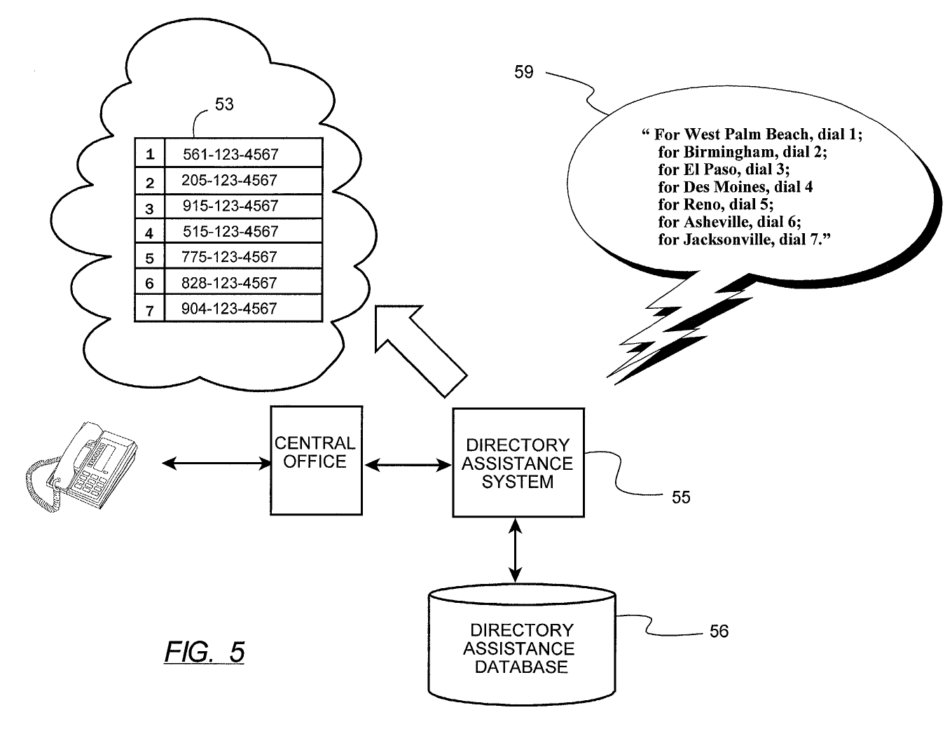

In a second embodiment of the invention, a method is provided for calling party to place an inter-LATA telephone call to a destination party by entering the local line number and then selecting the geographic location of the destination party from a menu. In the scenario illustrated in FIG. 5, a caller has dialed either a 7 digit local digit string, 123-4567, either alone or prefixed with an incorrect area code. The call is routed to a directory assistance system 55, which queries the database 56 to determine the area codes of all assigned telephone numbers 53 in a specified network which correspond to the 7 digit number 123-4567. Each of the area codes is assigned a numerical value. The caller is then provided with a menu 59 of the geographic regions which correspond to the area codes. The caller is advised to dial a specific number on the touch tone keypad to complete the call to a given geographic regions, e.g. “For West Palm Beach, dial 1; for Birmingham, dial 2, for El Paso, dial 3” etc.

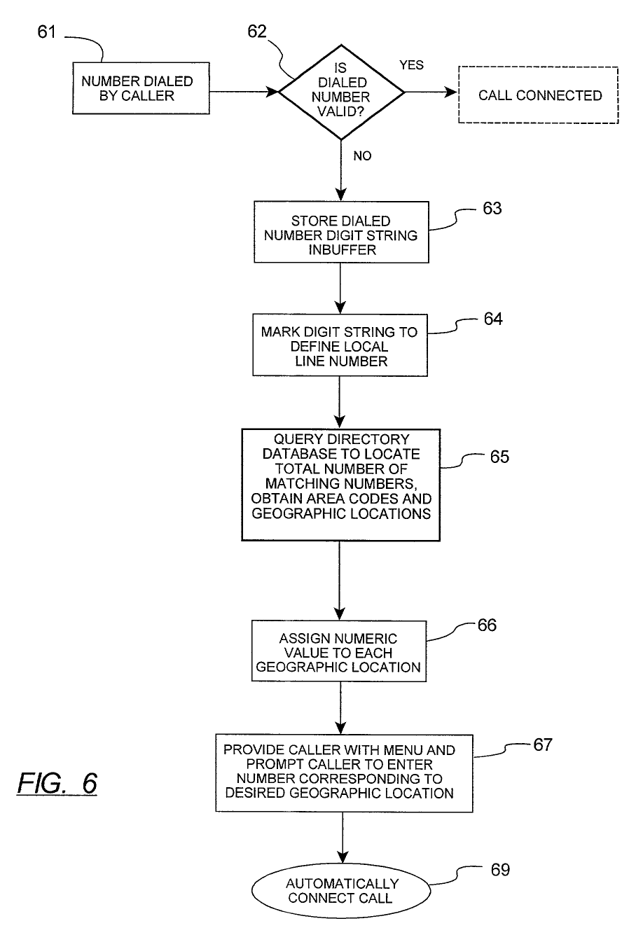

These steps are illustrated in FIG. 6. A caller initially dials a number 61. The number can be a seven-digit NANP number, or any assigned sequence number. If the number is valid (step 62), the call is connected. If it is not a valid number, the digit string dialed by the calling party is stored in a buffer 63 and marked to define the local line number 64. A directory database is queried to locate the total the number of matching local line numbers in the telephone system corresponding the local line number of the destination party and the associated area codes and geographic locations are obtained. (Step 65). In Step 66, a numeric value is assigned to each matching local line number. A computer-generated audio message presents a menu to the caller in which all the geographic locations are listed along with the associated numeric values (step 67), and the caller is instructed to dial the numeric value on the keypad of the local telephone device to be automatically connected using the correct area code. Alternatively, a voice recognition system can be used so that the caller can say the selected number aloud. The area code for the selected geographic location is then appended to the local line number stored in the buffer and the call is connected to the destination party (step 68). The caller can be charged a fee for automatic completion of the call.

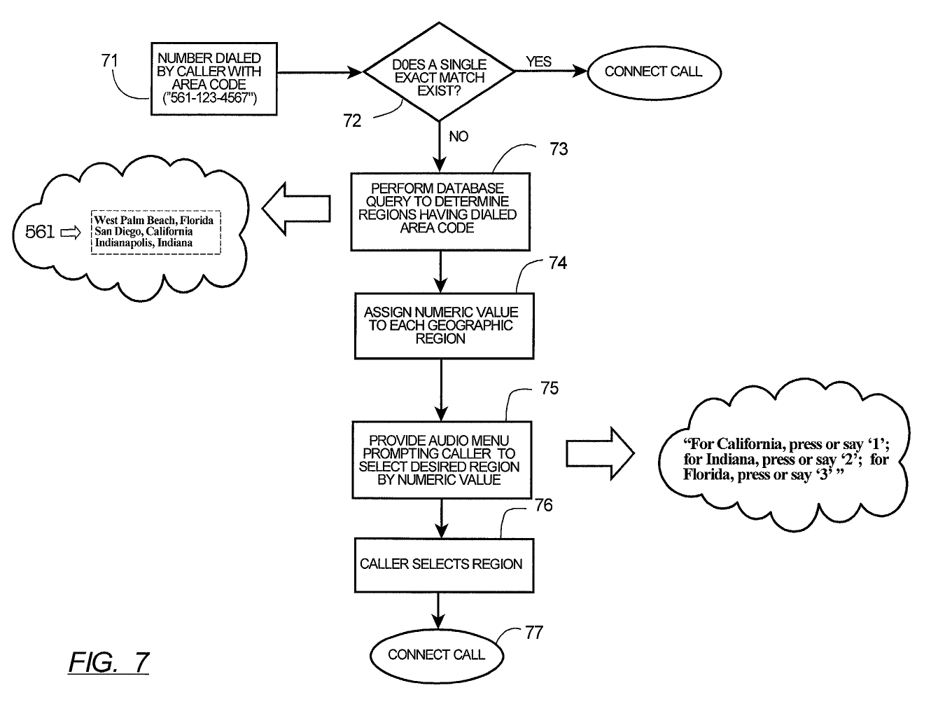

A third embodiment of the invention contemplates the implementation of a numbering system in which the same three-digit area code can simultaneously be used for more than one noncontiguous geographic region. In the example illustrated in FIG. 7, an area code of “561” is concurrently assigned to regions in Florida, California, and Indiana. In step 71, a caller dials the 10-digit number, “1-561-123-4567.” In step 72, it is determined if there is a single exact match for the number as dialed, and if so, the call is automatically connected. If there are multiple matches to the number, a database query is performed to determine all geographic regions having a “561” area code (step 73). At this point, the database query can narrow the list to include only those regions where an exact match to the dialed number exists. A numeric value is assigned to each geographic region (step 74). In step 75, the caller is provided with an audio menu prompting the caller to choose the desired geographic region. The caller can make a selection using the touch tone key pad, or if voice recognition systems are utilized, the caller can vocalize the number. For example, the caller would hear: “For California, press or say ‘1’; for Indiana, press or say ‘2’; for Florida, press or say ‘3’. After the caller responds by selecting a region (step 76), the call is connected (step 77). The method as herein described is directed to 10 digit NANP telephone numbers for illustrative purposes, however it will be appreciated that the method of the invention can be utilized in other types of numbering systems.

Such a system would provide numerous advantages over the present numbering system, and would provide great benefits to telephone subscribers. If duplicate area codes were permitted, the area code changes which are becoming increasingly frequent would no longer be necessary. Also, it would eliminate the somewhat unpopular practice of establishing “overlay” area codes, in which one region has multiple area codes and 10-digit dialing is required for all local calls. Such a system provide a solution to the number shortage problem, and the implementation would only require relatively minor modification of software and systems presently in use since it works within the parameters of the NANP system. An overall change in the NANP numbering system, on the other hand, would require wholesale system and infrastructure changes.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

I claim:

1. A method for appending a dialing prefix to a telephone number digit string which has been dialed from a calling party, said method comprising the steps of:
storing the dialed telephone number digit string in a buffer marking the telephone number digit string stored in said buffer to define the local line number;
checking whether the dialing prefix and local line number provides a valid network address;
determining a correct dialing prefix to reach the destination party advising the calling party of the correct dialing prefix required to reach the destination party;
appending the correct area code prefix to the local line number; and
automatically connecting the call to a destination party.

2. The method of claim 1, wherein the dialing prefix includes an area code.

3. The method of claim 1, wherein the dialing prefix includes an international prefix.

4. The method of claim 1, wherein the prefix includes a country code.

5. The method of claim 1, further including the step of prompting the caller for manual input of the correct dialing prefix.

6. The method of claim 1, further including the step of prompting the caller for confirmation that the call is to be automatically connected.

7. The method of claim 6, wherein said confirmation is accomplished by manual keypad entry.

8. The method of claim 1, wherein the calling party is advised of the correct dialing prefix via a computer-generated audio message.

9. The method of claim 1, further including the step of advising the caller via a computer-generated audio message that a fee will be incurred for automatic placement of the call.

10. The method of claim 1, further comprising the steps of connecting the caller to a directory assistance system wherein the caller can obtain the correct dialing prefix for the destination party.

11. The method of claim 1, further including the step of providing a list of area code prefixes that match the local line number.

12. The method of claim 11, further including the step of providing a list of geographic locations that incorporate the area code prefixes that match the local line number.

13. In a telephone system, a method whereby a calling party can place an inter-LATA telephone call to a destination party by entering the local line number and selecting the geographic location of the destination party from a menu; comprising the steps of:
storing the digit string dialed by the calling party in a buffer;
querying a directory database to locate the total the number of matching local line numbers in the telephone system corresponding the local line number of the destination party;
querying the directory database to obtain the associated area codes and geographic locations for the matching local line numbers;
assigning a numeric value to each matching local line number;
delivering to the calling party a computer-generated audio message in which each geographic location for the matching local numbers, and associated numeric values assign thereto, is conveyed to the calling party with instructions to the calling party to select the desired geographic location by pressing touch tone keys on the local telephone device corresponding to the assigned numeric value of the selected geographic location;
appending the prefix and area code for the selected geographic location to the local line number stored in the buffer; and
connecting the call to the destination party.

14. In a telephone system having a single area code assigned to a plurality of noncontiguous geographic regions, a method by which calling party can dial a digit string including the area code and selectively direct the call to the desired geographic region, comprising the steps of:
querying a data base to determine all geographic regions assigned to the area code;
assigning a numeric value to each geographic region;
delivering to the calling party a computer-generated audio message in which each geographic location and associated numeric values assign thereto are conveyed to the calling party with instructions to the calling party to select the desired geographic location, and;
connecting the call upon receiving the calling party selection.

15. The method of claim 14, wherein said step of conveying instructions to the calling party to select the desired geographic location includes the step of requiring the calling party to enter the numeric value assigned to the geographic location on the keypad.

16. The method of claim 14, wherein said step of conveying instructions to the calling party to select the desired geographic location includes the step of requiring the calling party to vocalize the assigned number.

17. The method of claim 15, further including the step of executing a database query to locate all ten-digit numbers in the telephone system which match the dialed digit string.

18. The method of claim 17, furthering including the steps of:
determining the number of existing exact matches, and connecting the call in the event one exact match exists.

19. The method of claim 15, further including the step of eliminating from the audio menu all geographic regions where an exact match does not exit.
